(19) United States
(12) Patent Application Publication
(10) Pub. No.: US 2026/0353080 A1
(43) Pub. Date: Nov. 5, 2026

(54) AUTOMATED HANDLING OF ACCESS CREDENTIALS FOR INTERNET OF THINGS (IOT) DEVICES

(71) Applicant: Target Brands, Inc., Minneapolis, MN (US)

(72) Inventors: Michael Christopher Beckel, Anoka, MN (US); Kent Myron Vareberg, Chaska, MN (US)

(21) Appl. No.: 19/196,078

(22) Filed: May 1, 2025

(51) Int. Cl. H04W 12/06; H04W 12/08

(52) U.S. Cl. CPC H04W 12/068; H04W 12/08

(57) ABSTRACT

In some implementations, a method is provided for automatically handling access credentials for internet of things (IoT) devices on a network. An access credential service updates access credentials of an IoT device, including automatically generating and updating the access credentials, storing the access credentials, and logging an access credential generation event. An IoT application executed by an IoT management device receives the access credential generation event, and transmits a request for the access credentials for the IoT device to the access credentials service. The access credentials service retrieves the access credentials from a data store and transmits the access credentials to the IoT application. The IoT application locally caches the access credentials and uses the locally cached access credentials to access the IoT device over the network.

### TECHNICAL FIELD

This specification generally relates to a platform for performing automated handling of access credentials for Internet of Things (IoT) devices across a computer network.

### BACKGROUND

Configuration tools can be used to configure and manage devices on a computer network. Network administrators can use such tools to scan a network for connected devices, and to manually configure and manage devices that are found during the network scan (e.g., through a graphical user interface). Device data can be exported to and employed by various device management utilities.

### SUMMARY

This document generally describes computer systems, processes, program products, and devices for performing automated handling of access credentials of Internet of Things (IoT) devices, such as physical sensors (e.g., including security cameras and/or other sorts of sensors), output devices, control devices, robotic devices, appliances, etc., across a computer network. The access credentials, for example, can include one or more of passwords, usernames, security codes, security tokens, personal identification numbers (PINs), or other digital access credentials used to request authorization for access to a computer device and/or service. In general, an enterprise may employ a vast number of devices across its facilities, including various different models from various different vendors, with each model possibly having different features and using different communications protocols and/or different access credential protocols. Further, the enterprise's fleet of devices may include a significant number of legacy devices, which can be unstable and challenging to maintain.

The solution facilitated by the presently described technology provides a device service platform and an access credential service platform for automatically managing devices (e.g., security cameras and/or other devices) in an enterprise environment, across the enterprise's facilities. The platforms decouple the management of devices and the handling of their access credentials from enterprise applications that are configured to interface with the devices, while improving the security posture of the devices. The platforms are hardware agnostic, in that devices of different models and vendors can be interchanged without having to refactor the enterprise applications. Management of the devices and the handling of their access credentials can be performed automatically by the platforms (e.g., under a plug and play model), and the devices can easily by leveraged by new applications.

Briefly, the device service platform and the access credential service platform involve firmware, protocols, and a system architecture for generating, managing, and using access credentials (e.g., passwords or other sorts of access credentials) to control access to platform devices (e.g., security cameras and/or other devices). A schedule is determined for automatically rotating access credentials across a fleet of devices, such that the access credentials are changed at a specified interval and in groups, with a subset of the devices having their access credentials changed at each interval. An access credential generation process includes randomly generating a globally unique (or nearly unique) access credential for each device. In some embodiments, the access credential creation process may employ an access credential generator that uses password formatting rules for multiple different device models, and that generates access credentials that conform to a common denominator across the models. The generated access credentials are stored in a repository, which is accessible through a front-end Application Programming Interface (API) of an access credential service, which enables authorized applications to retrieve the access credentials of specified devices. Some applications may locally cache the retrieved access credentials for later use.

In some implementations, a method for automatically handling access credentials for internet of things (IoT) devices on a network includes receiving, by an access credential service, a request to update access credentials of an IoT device; and in response to receiving the request to update access credentials of the IoT device, updating, by the access credential service, access credentials of the IoT device, the updating comprising: automatically generating access credentials for the IoT device; updating the access credentials of the IoT device; storing, at an access credential data store, the access credentials for the IoT device along with a unique identifier for the IoT device on the network; and logging an access credential generation event to an event data store, wherein the access credential generation event includes the unique identifier for the IoT device. The method also includes receiving, by an IoT application being executed by an IoT management device, the access credential generation event; in response to receiving the access credential generation event, transmitting, by the IoT application and to the access credential service, a request for the access credentials for the IoT device; in response to receiving the request for the access credentials for the IoT device, (i) retrieving, by the access credential service and from the access credential data store, access credentials for the IoT device, and (ii) transmitting, by the access credential service and to the IoT application, the access credentials for the IoT device; locally caching, by the IoT application and at the IoT management device, the access credentials for the IoT device; and using, by the IoT application, the locally cached access credentials for the IoT device to access the IoT device over the network.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The IoT device can be a security camera. The unique identifier of the IoT device can be a media access control (MAC) address. The event data store can be an event streaming platform. The IoT application can subscribe to the event data store. The request to update access credentials of the IoT device and the request for the access credentials for the IoT device can each be received through an application programming interface of the access credential service. Automatically generating access credentials for the IoT device can include executing a standard access credential generator that is configured to randomly generate access credentials that satisfy access credential specifications across a plurality of different device models of IoT devices. Automatically generating access credentials for the IoT device can include executing a model-specific access credential generator that is configured to randomly generate access credentials that satisfy a particular access credential specification for a particular device model of the IoT device. Updating the access credentials for the IoT device can include establishing a remote connection to the IoT device, and executing a configuration settings application script that updates the access credentials of the IoT device, using a protocol of a particular device model of the IoT device. A plurality of IoT device groups can be defined, and a substantially similar number of the IoT devices can be assigned to each IoT device group of the plurality of IoT device groups. An access credential update schedule can be defined. The IoT devices of a given IoT device group can be scheduled to undergo access credential updates during a same time period, and the IoT devices of different IoT device groups can be scheduled to undergo access credential updates during different time periods. In response to determining that a time period of one of the IoT device groups has begun according to its access credential update schedule, requests can be automatically transmitted to the access credential service during the time period, to update access credentials of IoT devices of the one of the IoT device groups. User-facing access credentials entered through a user interface of the IoT application can be received by the IoT application being executed by the IoT management device. The IoT application can validate the user-facing access credentials. In response to a successful validation of the user-facing access credential, the locally cached access credentials for the IoT device can be used to access the IoT device over the network, without receiving or exposing the locally cached access credentials through the user interface.

The systems, devices, program products, and processes described throughout this document can, in some instances, provide one or more of the following advantages. A schedule can be generated and maintained for periodically performing access credential updates for various devices across an enterprise, to ensure that an access credential service is not overwhelmed with concurrent requests for access credential updates, while maintaining overall system security. Through automated handling operations access credentials can be generated in a randomized manner, such that each device has (or is likely to have) unique access credentials across an enterprise. Access credentials can be updated and stored in a secure manner, such that human operators are not given direct access to the access credentials. By using a standard access credential generator that is configured to generate access credentials that are valid across a variety of different models, a code base for generating access credentials can be simplified. By using model-specific access credential generators that are configured to generate access credentials that conform to the specification of particular models, a code base for generating access credentials may be more complex, however the security features that are inherently included in particular models may be more effectively leveraged. By caching access credentials for a device, an application can access the device without direct operator interaction and without repeatedly retrieving the access credentials from an access credential service, thereby improving responsiveness of the application, while conserving communication bandwidth and processing resources for scenarios in which the application is to frequently access and/or interact with the device. Use of cached access credentials by an application in the background can improve a security posture of a devices, by not exposing the device's access credentials to a human operator. A centralized service can manage access credential changes for various different applications, thus serving to reduce communication overhead for the applications, while avoiding potential device lockouts that may occur when the applications do not have current access credentials of interfaced devices.

Other features, aspects and potential advantages will be apparent from the accompanying description and figures.

### DESCRIPTION OF DRAWINGS

FIG. 1 depicts an example system for performing automated handling of access credentials for Internet of Things (IoT) devices across a computer network.

FIGS. 2A-2E depict an example illustrative process for performing automated handling of access credentials for Internet of Things (IoT) devices across a computer network.

FIG. 3 is a flow diagram of an example technique for performing automated handling of access credentials for Internet of Things (IoT) devices.

FIG. 4 is a flow diagram of an example technique for automatically handling a request for access credentials.

FIG. 5 is a schematic diagram that shows an example of a computing system.

Like reference symbols in the various drawings indicate like elements.

### DETAILED DESCRIPTION

This document describes technology that can generate, manage, and use access credentials (e.g., passwords or other sorts of access credentials) of Internet of Things (IoT) devices (e.g., security cameras and/or other sorts of devices). A schedule can be determined for automatically rotating access credentials across a fleet of devices, such that the access credentials are changed at a specified interval and in groups. An access credential generation process can include randomly generating a globally unique (or nearly unique) access credential for each device. The generated access credentials can be stored in a repository, which can be made accessible through a front-end Application Programming Interface (API) of an access credential service, which enables authorized applications to retrieve the access credentials of specified devices. Some applications may locally cache the retrieved access credentials.

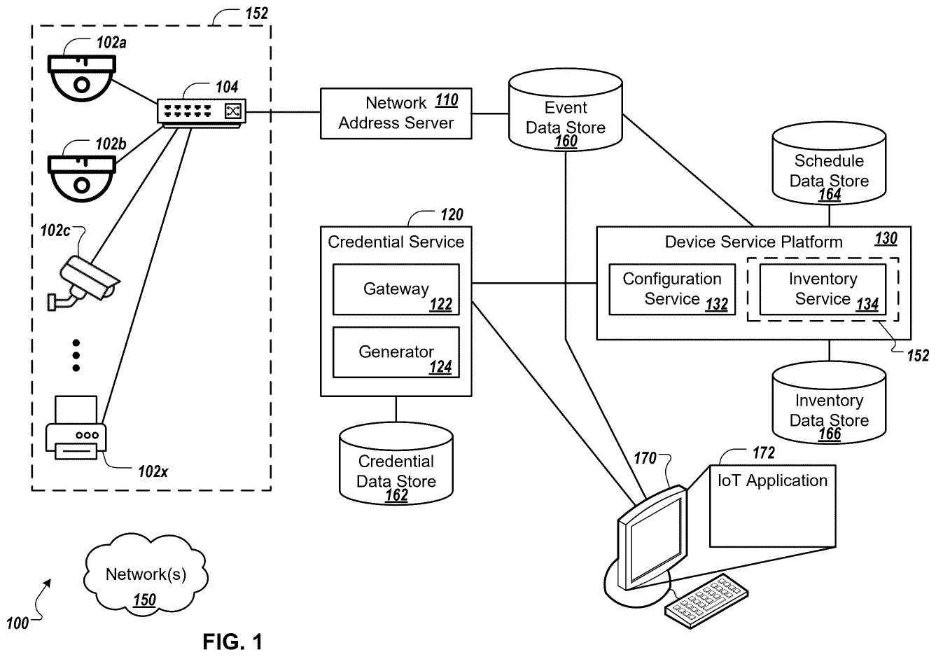

FIG. 1 depicts an example system 100 for performing automated handling of access credentials for Internet of Things (IoT) devices across a computer network. In general, the system 100 can include various computing devices, computing server systems, and data stores, configured to communicate with each other over one or more networks. For example, the system 100 can include various Internet of Things (IoT) devices (e.g., devices 102a, 102b, 102c, 102x, etc.), various network routers and/or switches (e.g., switch/router 104), a network address server 110 (e.g., a Dynamic Host Configuration Protocol (DHCP) server, or another sort of server that is configured to assign network addresses (e.g., Internet Protocol (IP) addresses) to client devices, an access credential service platform 120, a device service platform 130, various data stores (e.g., event data store 160, access credential data store 162, schedule data store 164, and inventory data store 166), and a client computing device 170, that can communicate and exchange data over networks 150 and 152 (e.g., including one or more LANs (local area networks), WANs (wide area networks), and/or the Internet.

The Internet of Things (IoT) devices 102a-x, for example, can represent various sorts of devices that can be individually addressable on a network, that can be connected to the network, and that can send and receive data over the network. For example, the IoT devices 102a-x can include various sorts of physical sensors (e.g., motion sensors, temperature sensors, sound sensors, light sensors, cameras, etc.), various sorts of output devices (e.g., speakers, lighting units, displays, printers, etc.), control devices, robotic devices, appliances, and so forth. In general, an entity (e.g., an individual, an organization, etc.) can manage a network that possibly includes multiple different types of IoT devices, with some devices possibly being different instances of a same device model. In the present example, IoT devices 102a and 102b each represent different instances of a same model of security video camera (e.g., “Model N”), device 102c represents an instance of a different model of security video camera (e.g., “Model O”), and device 102x represent an instance of another type of IoT device (e.g., a terminal, a display, a printer, or another sort of non-camera device).

The switch/router 104, for example, can handle communications between the IoT devices 102a-x, the network address server 110, the access credential service platform 120, the device service platform 130, that data stores 160, 162, 164, and 166, and the client computing device 170, over the networks 150 and 152. A switch, for example, can be configured to forward data packets between the IoT devices 102a-x and other devices on the network 152 (e.g., a local area network (LAN)). A router, for example, can be configured to forward data packets between the IoT devices 102a-x and other devices on the network 150 (e.g., a wide area network (WAN) and/or the Internet). Forwarding data packets can be performed by the switch/router 104, for example, based on a Media Access Control (MAC) address and/or an Internet Protocol (IP) address of a destination device.

The network address server 110, for example, can represent a server that is configured to assign network addresses and other network parameters to devices on a network. For example, the network address server 110 (e.g., a Dynamic Host Configuration Protocol (DHCP) server) can employ a protocol to automatically assign a network address (e.g., an Internet Protocol (IP)) address to any of the IoT devices 102a-x when the devices attempt to connect to the network(s) 150. Techniques for assigning an IP address, for example, can include dynamic allocation, automatic allocation, and/or manual allocation.

The access credential service platform 120, for example, can represent a platform that is implemented across multiple servers, including but not limited to network servers, web servers, application servers, or other suitable computing servers. In general, the access credential service platform 120 can be configured to perform various operations for generating, storing, retrieving, and transmitting access credentials for Internet of Things (IoT) devices (e.g., at least some of the IoT devices 102a-x). Each of the various operations, for example, can be implemented through one or more software components (e.g., through applications, modules, objects, or other suitable software components), which may be combined or separate, and may be co-located (e.g., executed by a same server) or distributed (e.g., executed by different servers). In the present example, the access credential service platform 120 includes a gateway component 122 and an access credential generator component 124. In general, the gateway 122 can be configured to handle communications and data requests from other system components (e.g., through an application programming interface (API)), and the access credential generator 124 can be configured to randomly generate access credentials for an IoT device (e.g., at least some of the IoT devices 102a-x) according to a format that is used by the device.

The device service platform 130, for example, can represent a platform that is implemented across multiple servers, including but not limited to network servers, web servers, application servers, or other suitable computing servers. In general, the device service platform 130 can be configured to perform various operations for automatically configuring Internet of Things (IoT) devices (e.g., at least some of the IoT devices 102a-x), and for automatically managing an inventory of such devices. Each of the various operations, for example, can be implemented as a computer service (e.g., through software components such as applications, modules, objects, or other suitable software components), which may be combined or separate, and may be co-located (e.g., executed by a same server) or distributed (e.g., executed by different servers). In the present example, the device service platform 130 includes a configuration service 132 and an inventory service 134. In general, the configuration service 132 can be configured to automatically configure at least some of the IoT devices 102a-x, and the inventory service 134 can be configured to automatically manage at least some of the IoT devices 102a-x as part of an inventory of devices that is maintained by the system 100.

While the access credential service platform 120 and the device service platform 130 of the present example are show as being separate platforms, in some examples, some or all of the platform components can be combined into a single platform. For example, components of the access credential service platform 120 can be integrated into the device service platform 130 (e.g., implemented on a same server or server cluster) such that communication overhead between the components are reduced. As another example, components of the access credential service platform 120 and the device service platform 130 can be separated to improve a security posture of the system 100.

The client computing device 170, for example, can represent various forms of stationary or mobile computing devices including, but not limited to a desktop computer, a laptop computer, a tablet computer, a personal digital assistant (PDA), a smartphone, or other processing devices. In general, the client computing device 170 can be used to execute an Internet of Things (IoT) application 172 that is used to access and interact with (e.g., receive status data from and/or provide control commands to) some or all of the IoT devices 102a-x. The client computing device 170, for example, can include various input devices (e.g., keyboard, mouse, pointer, touchscreen, microphone, etc.) for receiving input from a device operator, and various output devices (e.g., display, printer, speaker, etc.) for presenting output to the device operator.

Each of the various data stores (e.g., event data store 160, access credential data store 162, schedule data store 164, and inventory data store 166) can represent one or more databases, file systems, and/or cached data sources. As another example, two or more of the data stores 160, 162, 164, and 166 may be combined into a single data store. In general, the access credential service platform 120 can be configured to perform various data operations (e.g., selecting, updating, deleting, inserting, etc.) on the data maintained by the access credential data store 162 and the event data store 160, and the device service platform 130 can be configured to perform similar data operations on the data maintained by event data store 160, the schedule data store 164, and the inventory data store 166. The event data store 160 (which may include a network event data store and a device event data store), for example, can be configured to maintain event data (e.g., events related to name changes, firmware changes, password resets, reboots, factory resets, configuration changes, unresponsive incidents, unauthorized incidents, or other sorts of device events) that pertain to the IoT devices 102a-x. The access credential data store 162, for example, can be configured to maintain data that pertains to the access credentials and identifiers (e.g., Media Access Control (MAC) identifiers, Internet Protocol (IP) addresses, locations, etc.) of devices that are being serviced by the device service platform 130. The schedule data store 164, for example, can be configured to maintain data that pertains to generated schedules for automatically servicing particular devices or groups of devices. The inventory data store 166, for example, can be configured to maintain data that corresponds to devices that have been configured by (and are currently being managed by) the device service platform 130.

The networks 150 and 152, for example, can represent computer communication networks that are maintained by and/or used by an entity (e.g., an individual, an organization, etc.) that operates the system 100. In general, the network 150 can represent a wide area network (WAN) and/or the Internet, whereas the network 152 can represent a local area network (LAN). In the present example, the network 150 includes server(s) for running one or more centralized services of the access credential service platform 120 (e.g., the gateway 122 and the access credential generator 124) and of the device service platform 130 (e.g., the configuration service 132), the various data stores 160, 162, 164, and 166, and the network address server 110. The network 152 in the present example includes the various IoT devices 102a-x and network devices for handling network communication to and from the devices (e.g., the switch/router 104), and can optionally include server(s) for running one or more localized services of the device service platform 130 (e.g., the inventory service 134). For example, the network 152 can be a LAN that provides network services for a facility that includes the IoT devices 102a-x. In some examples, the system 100 can include multiple LANs, with each LAN providing local network services for a respective facility that includes a respective set of IoT devices. The multiple LANs, for example, can each be configured to communicate with the network(s) 150 (e.g., a WAN and/or the Internet) of the system 100 to access the network address server 110 and centralized services of the access credential service platform 120 and the device service platform 130.

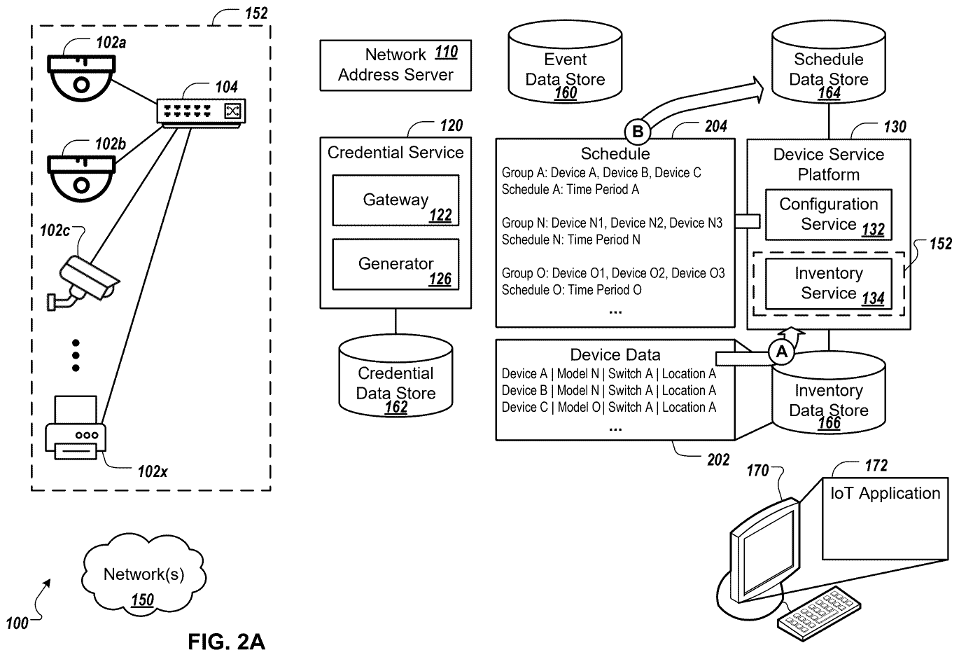

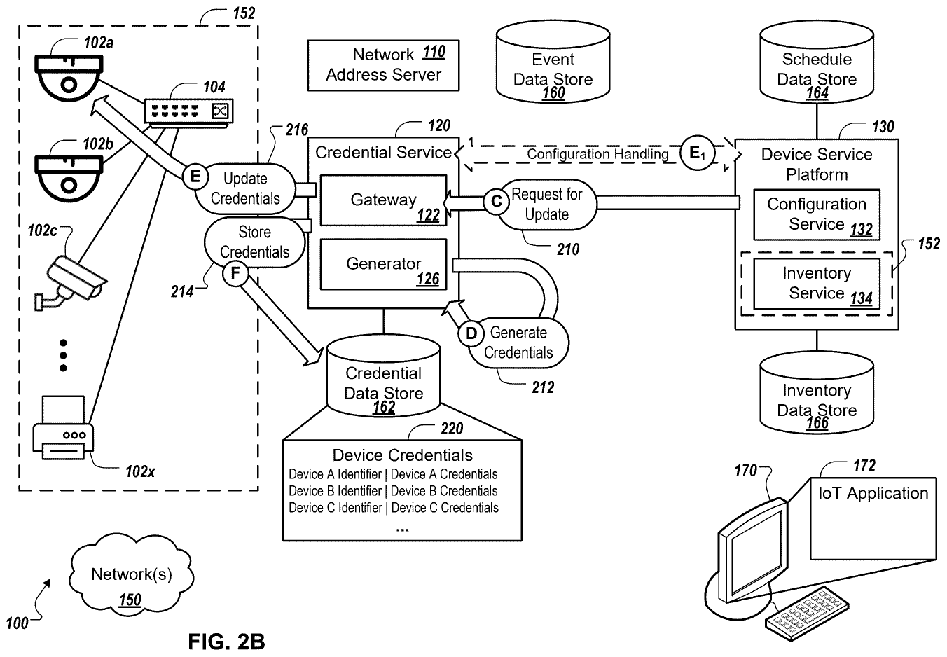

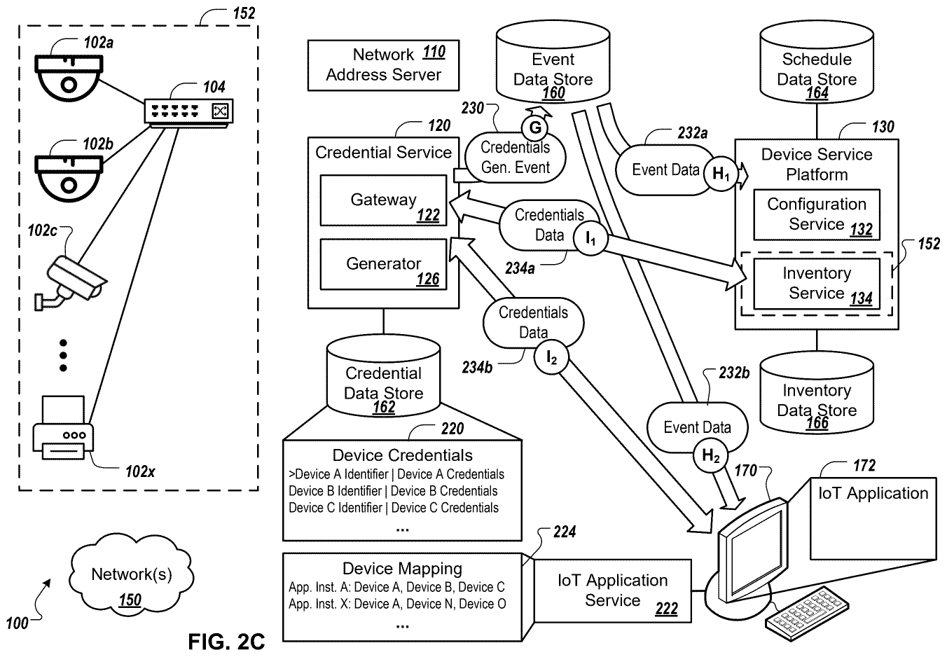

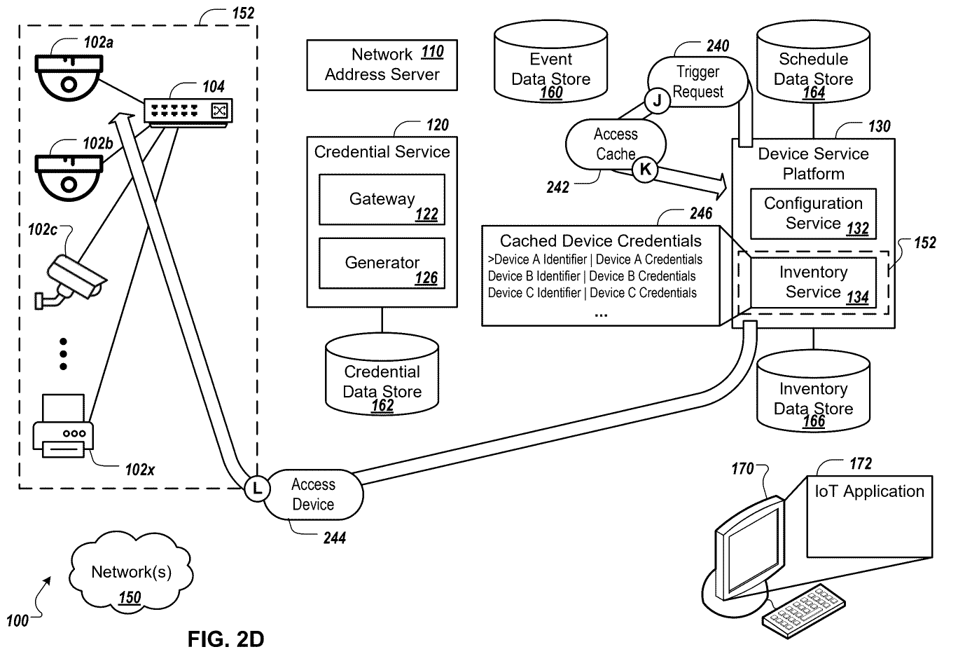

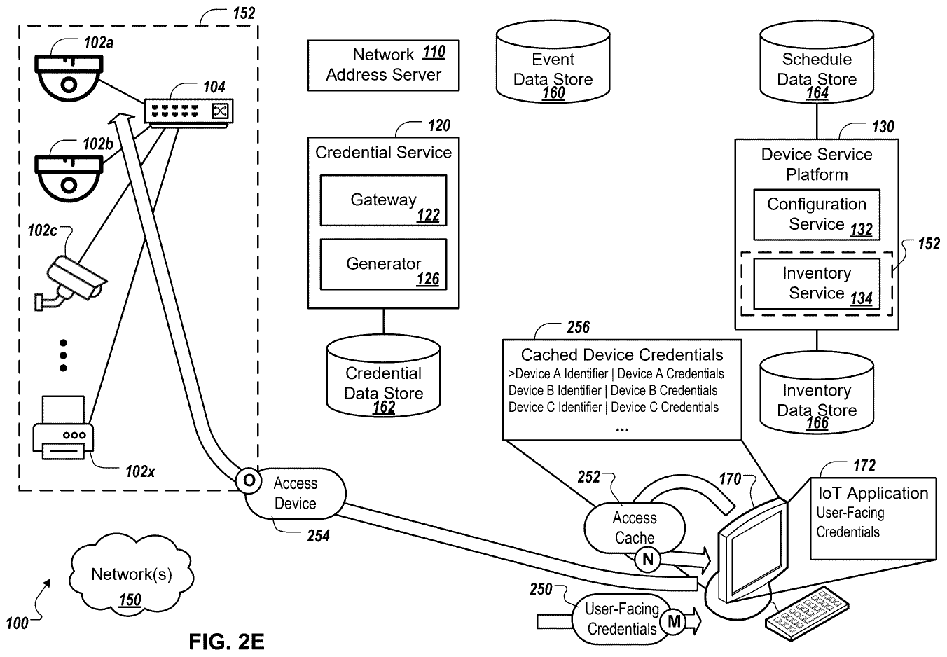

Referring now to FIGS. 2A-2E, an example illustrative process is shown for performing automated handling of access credentials for Internet of Things (IoT) devices (e.g., cameras and/or other types of devices) across a computer network, as represented in example stages (A) to (O). Stages (A) to (O) may occur in the illustrated sequence, or they may occur in a sequence that is different than in the illustrated sequence and/or two or more stages (A) to (O) may be concurrent. In some examples, one or more stages (A) to (O) may be repeated multiple times when handling access credentials for the IoT devices. Further, and with respect to stages (A) to (O), an example data flow through the system 100 is illustrated, with arrows showing a general direction of the flow of data. However, it is to be understood that any of the stages (A) to (O) can potentially include bi-directional communication between system components, with either of the components potentially initiating a transfer of data between the components (e.g., using push, pull, application programming interface (API) calls, data subscription, etc.).

Referring to FIG. 2A, operations are shown for generating an access credential update schedule. In general, an enterprise may employ a vast number of devices across its facilities (e.g., many thousands of devices across various different facilities of the system 100). To ensure that the access credential service 120 is not overwhelmed with concurrent requests for access credential updates, for example, a schedule can be generated and maintained for periodically performing access credential updates for the various devices across the enterprise. Thus, the access credentials of each device can be updated at an appropriate frequency such that overall system security is maintained, while evenly distributing the access credential update tasks such that system resources for performing the tasks (e.g., processing resources, communication bandwidth) are consistently employed over time.

During stage (A), device data can be received for Internet of Things (IoT) devices for which an access credential update schedule is to be generated. For example, the device service platform 130 can receive device data 202 from the inventory data store 166 that pertains to some or all of the devices 102a-x. In the present example, the device data 202 can include, for each of the devices 102a-x (e.g., “Device A,” “Device B,” “Device C,” etc.), a unique identifier of the device (e.g., a media access control (MAC) address, or another sort of unique identifier), a model identifier, a switch identifier, a location identifier (an identifier of a facility in which the device is located), and other relevant data that pertains to the device.

During stage (B), an access credential update schedule can be generated or modified. For example, the device service platform 130 can generate (or modify) an access credential update schedule 204, based at least in part on the received device data 202. In some implementations, generating an access credential update schedule may include defining a plurality of device groups, and assigning a substantially similar number of devices to each device group. For example, the device service platform 130 can define “Group A,” “Group N,” “Group O,” etc., with the devices represented in the received device data 202 being evenly distributed among the defined groups. In the present example, “Device A,” “Device B,” and “Device C” are assigned to “Group A,” “Device N1,” “Device N2,” and “Device N2” are assigned to “Group N,” “Device O1,” “Device O2,” and “Device O3” are assigned to “Group O,” and so forth. The number of defined groups, for example, can generally correspond to a time interval (e.g., a number of weeks, hours, days, etc.) between access credential updates for the devices, according to the security objectives of an enterprise that manages the devices. For example, if the enterprise prefers to update the access credentials of each device once every sixty days (or another suitable time interval, such as once every one hundred twenty days, once every one hundred eighty days, etc.), the enterprise can define sixty groups, and the devices can be even distributed among the sixty groups. As another example, the devices of each of the sixty groups can be further evenly divided into subgroups (e.g., four, eight, twelve, or another suitable number of subgroups), with each subgroup being associated with a different portion of a day. Other grouping schemes are possible.

In some implementations, the devices of a given device group (or subgroup) can be scheduled to undergo access credential updates during a same time period, and devices of different device groups (or subgroups) can be scheduled to undergo access credential updates during different time periods. In response to determining that a time period of one of the device groups has begun according to its access credential update schedule, for example, requests can be transmitted by the device service platform 130 to the access credential service 120 during the time period, to update access credentials of devices of the device group. Referring to the schedule 204, for example, when “Time Period A” begins (e.g., day one of a sixty-day cycle), devices included in “Group A” undergo access credential updates. Continuing the present example, when “Time Period N” begins (e.g., day two of the sixty-day cycle), devices included in “Group N” undergo access credential updates. Further, when “Time Period O” begins (e.g., day three of the sixty-day cycle), devices included in “Group O” undergo access credential updates, and so forth. Updating of access credentials can be staggered throughout a time period (e.g., through the further allocation of devices to subgroups, through finer grained scheduling mechanisms, or through other suitable techniques) to ensure that the access credential service 120 is not overloaded with requests at any given time. Thus, in the present example, each of the devices assigned to “Group A,” “Group N,” and “Group O” undergo an access credential update once every specified time interval (e.g., once every sixty days) in a distributed and orderly manner.

While the present example shows each device undergoing an access credential update according to a same time interval (e.g., once every sixty days, or another suitable time interval), other scheduling schemes are possible. For example, devices of different models and/or at different locations (e.g., facilities in which devices are located) can be associated with different intervals for scheduled access credential updates. As another example, the grouping of devices can include grouping devices of a same model and/or location together, or distributing the devices among different groups. As another example, a rotating queue can be implemented, in which a device is placed at the end of the queue after having its access credentials updated, with no set schedule for an access credential update process-rather, a variable number of access credential updates can be performed by the access credential service 120 for a time period, according to its current capacity during the time period.

Also, while the present example shows the scheduling of access credential updates for an existing fleet of active devices across an enterprise (e.g., a group of devices that are managed together), it is understood that devices may be added to and removed from the fleet over time. When devices are added and/or removed, for example, the system changes can be reflected in the inventory data store 166, and the device service platform 130 can detect the changes. In response to detecting the addition or removal of one or more devices, for example, the device service platform 130 can receive device data 202 that reflects the changes, and can update the schedule 204 appropriately. For example, when a device is removed from the system 100, the device can be removed from the schedule 204 or queue. As another example, when a device is added to the system 100, the device can be added to the schedule 204 or queue (possibly after performing an initial access credential update to clear a default password). Further, the device service platform 130 can periodically (e.g., once per day, week, month, etc.) rebalance the schedule 204 to account for added/removed devices.

Referring to FIG. 2B, operations are shown for automatically handling requests to update access credentials of Internet of Things (IoT) devices, including the automatic generation, updating, and storing of access credentials. Through the automated operations, for example, the system 100 can automatically generate access credentials in a randomized manner, such that each device has (or is likely to have) unique access credentials across an enterprise. Further, the system 100 can automatically update and store the access credentials in a secure manner, such that human operators are not given direct access to the access credentials.

During stage (C), a request to update the access credentials of an Internet of Things (IoT) device can be received. For example, the access credential service 120 can receive a request 210 to update the access credentials of the device 102a (e.g., “Device A”) from the device service platform 130. The request 210, for example, can include various sorts of identification data for the device 102a, such as one or more device identifiers (e.g., the device's MAC address, the device's assigned IP address, the device's assigned host name, etc.), device model information (e.g., “Model N”), a switch identifier (e.g., “Switch A”), a device location identifier (e.g., “Location A”), and/or other sorts of identification data. In some implementations, the identification data for the device 102a may be retrieved from the inventory data store 166 by the inventory service 134. In some implementations, the identification data for the device 102a can be included in the schedule 204 (shown in FIG. 2A).

In the present example, the request 210 can be generated and transmitted in response to determining that a time period of a device group (e.g., “Group A”) to which the device 102a (e.g., “Device A”) has been assigned has begun. Once the time period has begun, for example, the device service platform 130 can process a list of devices in the device group (e.g., “Group A”), by sequentially generating and transmitting requests to update access credentials for each device in the group over the time period (optionally staggering transmission of the requests such that the access credential service 120 is not overburdened with concurrent requests). As another example, the request 210 can be generated and transmitted on an ad hoc basis (e.g., in response to a new device being added to the system 100, in response to a request for the device service platform 130 to update the access credentials of a particular device, etc.).

In some implementations, a request to update access credentials of an IoT device can be received through an application programming interface (API) of an access credential service. For example, the gateway 122 of the access credential service 120 can provide an API through which the request 210 is received. The device service platform 130, for example, can format its requests for access credential updates (e.g., the request 210) according to the specification of the API of the gateway 122.

During stage (D), after receiving the request to update the access credentials of the IoT device, the access credentials can be generated. For example, in response to receiving the request 210 from the device service platform 130 through the gateway 122, the access credential service 120 can use the access credential generator 126 to randomly generate access credentials 212 for the device 102a. The access credential generator 126, for example, can include a pseudo-random number generator (PRNG) that employs one or more algorithms to mimic randomness, a true random number generator (TRNG) that uses physical events to produce randomness, or another suitable random number generator.

In some implementations, generating access credentials may include executing a standard access credential generator that is configured to randomly generate access credentials that satisfy access credential specifications across a plurality of different device models of IoT devices. In general, different models may have different access credentials formats. For a scenario in which an access credential is a password (e.g., a secret sequence of characters), password formats for different device models may involve different minimum lengths, different maximum lengths, different allowable character sets, different character mix rules (e.g., at least one lowercase character, at least one uppercase character, at least one number, at least one special character), and so forth. In the present example, the access credential generator 126 can be configured to generate access credentials (e.g., passwords) in a common format that satisfies the access credential specifications of a variety of device models (e.g., both Model N and Model O). By using a standard access credential generator that is configured to generate access credentials (e.g., passwords) that are valid across a variety of different models, for example, a code base for generating access credentials can be simplified.

In some implementations, generating access credentials may include executing a model-specific access credential generator that is configured to randomly generate access credentials that satisfy a particular access credential specification for a particular device model of an IoT device. For example, the access credential generator 126 can receive information (e.g., information included in the request 210) that identifies a device model of the device 102a (e.g., “Model N”), and can execute code that is specifically configured to randomly generate access credentials for devices of “Model N.” As another example, if the access credential generator 126 were to receive information in the request 210 that identifies the device as being of a different model (e.g., “Model O”), the generator 126 can execute different code that is specifically configured to randomly generate access credentials of “Model O.” By using model-specific access credential generators that are configured to generate access credentials (e.g., passwords) that conform to the specification of particular models, for example, a code base for generating access credentials may be more complex, however the security features that are inherently included in the access credentials of particular models may be more effectively leveraged.

In general, for both standard access credential generators and model-specific access credential generators, a randomly generated password may be considered as being unique or nearly unique across a fleet of IoT devices. That is, if a randomly generated password were to become compromised, a malicious actor would be unable to use the compromised password to access another device in the fleet with a reasonable expectation of success.

During stage (E), after the access credentials have been generated for the IoT device, the device's access credentials can be updated. For example, the access credential service 120 can receive the generated access credentials from the access credential generator 126, and can apply an access credentials update 216 to the device 102a. In general, applying an access credentials update can include establishing a secure remote connection to a device (e.g., using an encrypted communication protocol such as Hypertext Transfer Protocol Secure (HTTPS), Internet Protocol Security (IPsec), Transport Layer Security (TLS), or another suitable protocol), and executing an application script that applies the access credentials to the device.

In some implementations, the access credential service 120 can apply an access credentials update directly to an IoT device. For example, the access credential service 120 can use the gateway 122 to directly and securely communicate with the device 102a (e.g., using an encrypted communication protocol), and can directly the access credentials update 216 to the device 102a. In the present example, the access credential service 120 can establish a secure remote connection to the device 102a over the networks 150, 152, (e.g., via the gateway 122) and can apply the access credentials update 216 to the device 102a using a configuration settings application script that has been configured to apply access credentials for “Model N” devices (e.g., using communication and update protocols that are specific to that model).

In some implementations, the access credential service 120 can employ the device service platform 130 as an intermediary for applying an access credentials update to an IoT device. Such implementations can include examples in which the access credential service 120 is separate from the device service platform 130, and examples in which the access credential service 120 is included in the device service platform 130. For example, during stage (E₁), the access credential service 120 can securely transmit generated access credentials for a device (e.g., device 102a) to the device service platform 130 (e.g., using an encrypted communication protocol), and in turn the device service platform 130 can use the configuration service 132 to apply the generated access credentials to the device 102a (e.g., using an encrypted communication protocol). In the present example, the device service platform 130 can establish a secure remote connection to the device 102a over the networks 150, 152, (e.g., using the configuration service 132) and can apply the generated access credentials to the device 102a using a configuration settings application script that has been configured to apply access credentials for “Model N” devices (e.g., using communication and update protocols that are specific to that model).

During stage (F), after the access credentials have been generated for the IoT device, the device's access credentials can be stored. For example, the access credential service 120 can store the generated access credentials (here shown as access credentials 214) for the device 102a at the access credential data store 162. In the present example, the access credentials 214 for the device 102a (e.g., “Device A”) can be stored along with one or more unique identifiers for the device on the network (e.g., the device's MAC address and/or the device's network IP address). The updated access credentials 214, for example, can be securely maintained at the access credential data store (e.g., in an encrypted state), along with access credentials 220 of other devices included in the system 100 (e.g., “Device B,” “Device C,” etc.).

It is to be noted that the operations performed during stage (E) (e.g., updating device access credentials) and stage (F) (e.g., storing device access credentials) can be performed after the access credentials are generated at stage (G) in either sequence. As another example, stages (E) and (F) can be performed concurrently after the access credentials have been generated at stage (G).

Referring to FIG. 2C, operations are shown for automatically notifying various Internet of Things (IoT) applications of updates to access credentials of IoT devices. In general, an IoT application can be a computer application that is executed by a computing device (e.g., a server system, a client computing device, etc.) and that is used to access and interact with (e.g., receive status data from and/or provide control commands to) some or all of the devices 102a-x. To access and interact with an IoT device, for example, the IoT application can establish a secure remote connection with the device (e.g., over the networks 150, 152), and can use access credentials of the device to initiate a communication session with the device (e.g., through a login protocol).

In the present example, the IoT application 172 executed by the client computing device 170 is a user-facing application (e.g., an application that a human operator directly interacts with to engage application operations). The IoT application 172, for example, can be used to monitor and/or control the devices 102a (e.g., “Device A”), 102b (e.g., “Device B”), and 102c (e.g., “Device C”)—which here represent video cameras that are configured to capture video images of a facility (e.g., at “Location A”) of an enterprise. Further, in the present example, the inventory service 134 of the device service platform 130 may be considered as a non-user-facing application (e.g., an application that automatically interacts with IoT devices without direct human prompting or control). The inventory service 134, for example, can be configured to automatically collect device data that pertains to at least a portion of the devices 102a-x (e.g., MAC addresses, assigned IP addresses, assigned host names, physical locations, configuration settings, etc.). The device data, for example, can be periodically collected according to a predetermined schedule (e.g., once per hour, once per four hours, once per day, or according to another predetermined schedule), and once collected, the device data can maintained at the inventory data store 166, and can be provided to downstream processes (e.g., processes that provide status information for devices across the system 100, processes that reconfigure devices in response to the detection of specified settings and/or conditions, etc.).

In some implementations, an IoT application may communicate with an IoT application service that is configured to maintain a mapping between IoT devices and one or more IoT applications that interface with the IoT devices, and that is configured to manage access credentials updates of the IoT devices, for the one or more IoT applications. For example, the IoT application 172 can communicate with an IoT application service 222 that is configured to maintain a device mapping 224 that maps instances of the IoT application 172 (e.g., instances running on different computing devices) to identifiers of the IoT devices 102a-x. The IoT application service 222, for example, can be a computer service that is executed by a same computing device as the IoT application 172, or that is executed a different computing device that is remote from a computing device that executes the IoT application 172. The device mapping 224, for example, can be maintained in local memory of the IoT application service 222, and/or can be maintained in persistent data storage (e.g., a database, a file structure, etc.).

In the present example, the device mapping 224 maintained by the IoT application service 222 includes an identifier of an instance of the IoT application 172 running on the client computing device 170 (e.g., “Application Instance A”), an identifier of an instance of the IoT application running on a different client computing device (e.g., “Application Instance X”), and so forth. Continuing the present example, the device mapping 224 includes, in association with “Application Instance A,” a list of identifiers (e.g., MAC addresses, IP addresses, host names, etc.) of devices that interface with “Application Instance A,” including “Device A,” “Device B,” and “Device C.” Similarly, the device mapping 224 includes, in association with “Application Instance X,” a list of identifiers of devices that interface with “Application Instance X,” including “Device A,” “Device N,” and “Device O.” In the present example, each of the application instances “Application A,” “Application X,” etc., can be decoder applications that provide simultaneous feeds from various security camera devices (e.g., “Device A,” “Device B,” “Device C,” “Device N,” “Device O,” etc.), however in other examples, the application instances can be other sorts of applications that interface with multiple different IoT devices.

As further described in examples below, the IoT application service 222 can provide application instances (e.g., “Application Instance A,” “Application Instance X,” etc.) with updated access credentials for any of the IoT devices 102a-x (e.g., security cameras and/or other sorts of IoT devices) that interface with the application instances. The IoT application service 222, for example, can update device mappings 224 in response to changes to devices with which the application instances interface, as the application instances are configured to begin interfacing with particular devices and/or are configured to stop interfacing with the devices. Further, the IoT application service 222 can track changes to access credentials of any of the IoT devices 102a-x, and can transmit access credential changes to application instances that are impacted by the access credential changes (e.g., application instances that interface with devices for which access credentials have changed). By operating as a centralized service that manages access credential changes for various different IoT applications (and application instances), for example, the IoT application service 222 can serve to reduce communication overhead for the IoT applications, while avoiding potential device lockouts that may occur when the IoT applications do not have current access credentials of interfaced IoT devices.

During stage (G), an access credential generation event can be logged to an event data store. For example, after generating, updating, and storing access credentials for the device 102a (e.g., as shown in FIG. 2B), the access credential service 120 can generate an access credential generation event 230, and can transmit the event 230 to the event data store 160. In the present example, the access credential generation event 230 can include one or more unique identifiers for the device 102a (e.g., the device's MAC address and/or the device's network IP address), and can optionally include other data for identifying the device on the networks 150, 152 (e.g., a switch identifier, a location identifier, etc.). The event data store 160, for example, can be configured to receive and store access credential generation events that occur when the access credentials of any of the devices 102a-x are generated, updated, and stored, among other sorts of events. In some implementations, an event data store can be an event streaming platform. For example, the event data store 160 store such events in an ordered log, and can publish streams of events for consumption by downstream processes being executed by various computing servers/devices (e.g., the device service platform 130, the client computing device 170, etc.).

During stages (H₁) and (H₂), data corresponding to access credential generation events can be received by various IoT applications being executed by various IoT management devices. For example, the IoT application 172 (e.g., a user-facing application) being executed by the client computing device 170, and the inventory service 134 (e.g., a non-user-facing application) of the device service platform 130 can each subscribe to a topic (e.g., a data feed name) that includes access credential generation events that occur after generating, updating, and storing access credentials for devices across the system 100. Optionally, the IoT application service 222 (e.g., a centralized service that monitors access credential generation events for multiple different IoT applications/instances) can subscribe to the topic, in lieu of the IoT application 172 (and/or other applications/instances operating in the system 100) subscribing to the topic. As another example, another sort of data transmission technique (e.g., data polling, data pushing, etc.) can be used to provide access credential generation event data to user-facing and non-user-facing applications. In the present example, during stage (H₁), the inventory service 134 of the device service platform 130 can receive access credential generation event data 232a that pertains to the generation of access credentials for the device 102a, from the event data store 160. Similarly, during stage (H₂), for example, the IoT application 172 executed by the client computing device 170 can receive access credential generation event data 232b (e.g., similar to the data 232a) that pertains to the generation of access credentials for the device 102a, from the event data store 160.

During stages (I₁) and (I₂), in response to receiving access credential generation events, requests for access credentials for an IoT device can be transmitted. In the present example, during stage (I₁), the inventory service 134 of the device service platform 130 can transmit a request for access credentials of the device 102a (e.g., including one or more unique identifiers of the device) to the access credential service 120 via the gateway 122. Similarly, during stage (I₂), the IoT application 172 executed by the client computing device 170 can transmit a request for access credentials of the device 102a (e.g., including one or more unique identifiers of the device) to the access credential service 120 via the gateway 122. Optionally, the IoT application service 222 can transmit the request for access credentials of the device 102a to the access credential service 120 via the gateway 122, in lieu of the IoT application 172 (and/or other applications/instances operating in the system 100) transmitting the request.

In some implementations, a request for access credentials for an IoT device can be received through an application programming interface (API) of an access credential service. For example, the gateway 122 of the access credential service 120 can provide an API through which requests for access credentials for IoT devices are received, with requesting applications/devices/servers formatting their requests for access credentials according to the specification of the API.

In the present example, upon receiving the requests for access credentials for the device 102a (e.g., “Device A”) through the gateway 122, the access credential service 120 can verify that the requesting applications/services/devices/servers are authorized to receive access credentials data that pertains to the device 102a (e.g., through an access permissions protocol that maps application/device/server permissions to particular IoT devices). If a requesting application/service/device/server is authorized, for example, the access credential service 120 can retrieve access credentials (e.g., access credentials 220 for “Device A”) for the device identified in the request, from the access credential data store 162. After retrieving the access credentials, for example, the access credential service 120 can securely transmit the retrieved access credentials (e.g., as an encrypted package using a secure communication protocol) to the requesting application/service/device/server. In the present example, during stage (I₁), the access credential service 120 can transmit access credentials data 234a (pertaining to the device 102a) to the inventory service 134 of the device service platform 130, and during stage (I₂), the access credential service 120 can transmit access credentials data 234b (also pertaining to the device 102a) to the IoT application 172 executed by the client computing device 170.

Optionally, the access credential service 120 can transmit the access credentials data 234b (pertaining to the device 102a) to the IoT application service 222, in lieu of the IoT application 172 (and/or other applications/instances operating in the system 100). After receiving the access credentials data 234b, for example, the IoT application service 222 can reference the device mapping 224 and can identify one or more IoT applications (and/or application instances) that interface with the device 102a (e.g., “Device A”). In the present example, the IoT application service 222 determines that both “Application Instance A” and “Application Instance X” interface with “Device A.” Thus, in the present example, the IoT application service 222 can forward the received access credentials data 234b to a first computing device that executes “Application Instance A,” and a second, different computing device that executes “Application Instance X.” Forwarding of the received access credentials 234b, for example, can include transmitting the credentials as an encrypted package using a secure communication protocol between the IoT application service 222 and a given application instance.

Upon receiving access credentials for an Internet of Things (IoT) device (e.g., either directly from the access credential service 120 or via the IoT application service 222 acting as an intermediary), an IoT application can locally cache the access credentials at an IoT management device. For example, the inventory service 134 (e.g., a non-user-facing IoT application) can cache the access credentials data 234a (pertaining to the device 102a) in local memory of the device service platform 130 (e.g., a type of IoT management device). As another example, the IoT application 172 (e.g., a user-facing IoT application) can cache the access credentials data 234b (also pertaining to the device 102a) in local memory of the client computing device 170 (e.g., another type of IoT management device). As described in further detail below, the cached access credentials data 234a, 234b, can be used by the respective IoT applications 134, 170, to access and interact with the IoT device 102a.

Referring to FIG. 2D, operations are shown for using locally cached access credentials of an Internet of Things (IoT) device, by a non-user-facing IoT application, to access the IoT device over a network. For example, the inventory service 134 (e.g., a non-user-facing application) can be configured to automatically collect device data that pertains to at least a portion of the devices 102a-x, according to a predetermined schedule (e.g., once per hour, once per four hours, once per day, or according to another predetermined schedule). The collected device data, for example, can be used by the inventory service 134 to provide information to downstream applications/services about the fleet of devices 102a-x, such as current statuses (e.g., online, offline, etc.), and current configuration settings. For example, a device's current configuration settings can be compared to the device's preferred configuration settings, to detect possible configuration drift (e.g., operation modification of settings). If drift is detected, for example, the device's configuration settings can be automatically returned to a desired configuration (e.g., by the configuration service 132). By caching the access credentials of various devices, the inventory service 134 can access the devices without direct operator interaction and without repeatedly retrieving access credentials from the access credential service 120—which can conserve communication bandwidth and processing resources for scenarios in which the inventory service 134 is to retrieve device information according to a frequent and repeated schedule.

During stage (J), a request to access an IoT device can be triggered. For example, the device service platform 130 can trigger a request 240 to access the device 102a. In general, a request to access an IoT device by a non-user-facing IoT application can be triggered by an automated schedule for accessing the device. According to the automated schedule, for example, the device service platform 130 can periodically (e.g., once per hour, once per four hours, once per day, etc.) trigger the request 240 for the inventory service 134 to access the device 102a over the networks 150, 152. In the present example, the request 240 can include one or more unique identifiers (e.g., a MAC address, an IP address, etc.) of the device 102a.

During stage (K), a local cache can be accessed. For example, the inventory service 134 can access a local cache 246 (e.g., in server memory of the device service platform 130) and can reference the cached access credentials of the device 102a using the one or more unique identifiers of the device. In the present example, the local cache 246 includes device identifiers and access credentials for the device 102a (“Device A”), the device 102b (“Device B”), the device 102c (“Device C”), etc.

During stage (L), the IoT device can be accessed. For example, the inventory service 134 can securely transmit a request 244 to access the device 102a over the network 152 (e.g., a LAN). In the present example, the request 244 can include the access credentials (e.g., “Device A Credentials”) for the device 102a, that were maintained in the local cache 246 of the inventory service 134. Upon accessing the device 102a using the device's cached access credentials, for example, the inventory service 134 can establish a secure communication session with the device, can retrieve data from the device (e.g., current configuration settings and other sorts of data), and can maintain the retrieved data at the inventory data store 166. As another example, the inventory service 134 can transmit control commands to the device 102a over the secure connection. By maintaining the inventory service 134 as a localized service (e.g., a service that runs on a same LAN 152 as the devices 102a-x for which it is to perform inventory operations), network traffic can be reduced for an enterprise across a WAN/Internet, while providing current device data and configuration settings data for devices of a facility to a centralized data store (e.g., the inventory data store 166) for reporting and analysis.

Although the present example shows a successful use of cached access credentials for accessing an IoT device over a network, in some scenarios, the cached access credentials may not permit access to the IoT device (e.g., for scenarios in which the cached access credentials are invalid due to data synchronization errors, for scenarios in which access credentials have been updated through a manual process, or other non-standard scenarios). For such scenarios, the inventory service 134 can transmit a request for current access credentials for the device 102a to the credential service 120 through the gateway 122. As another example, the inventory service 134 can raise an alert that indicates a possible system error or security breach in the system 100.

Referring to FIG. 2E, operations are shown for using locally cached access credentials of an Internet of Things (IoT) device, by a user-facing IoT application, to access the IoT device over a network. For example, the IoT application 172 (e.g., a user-facing application) can be configured to access and interact with (e.g., receive status data from and/or provide control commands to) at least a portion of the devices 102a-x, in response to commands provided through a user interface. By caching the access credentials of various devices, the IoT application 172 can access the devices without repeatedly retrieving access credentials from the access credential service 120—which can conserve communication bandwidth and processing resources for scenarios in which an operator of the IoT application frequently requests access to particular devices. Further, use of cached access credentials by the IoT application in the background can improve a security posture of the devices 102a-x, by not exposing the access credentials to a human operator.

During stage (M), user-facing access credentials can be received by an IoT application being executed by an IoT management device. For example, the IoT application 172 of the client computing device 170 can receive user-facing access credentials 250 (e.g., a username and password of a device operator) through a user interface of the application. In response to receiving the user-facing access credentials 250, for example, the IoT application 172 can validate the user-facing access credentials (e.g., by confirming whether the credentials belong to an authorized user of the application). If the credentials are valid, for example, the IoT application 172 can permit further user access to the operations of the application.

During stage (N), a local cache can be accessed. For example, the IoT application 172 can access a local cache 256 (e.g., in memory of the client computing device 170) and can reference the cached access credentials of the device 102a using the one or more unique identifiers of the device. In the present example, the local cache 256 includes device identifiers and access credentials for the device 102a (“Device A”), the device 102b (“Device B”), the device 102c (“Device C”), etc.

During stage (O), the IoT device can be accessed. For example, the IoT application 172 can securely transmit a request 254 to access the device 102a over the networks 150, 152. In the present example, the request 254 can include the access credentials (e.g., “Device A Credentials”) for the device 102a, that were maintained in the local cache 256 of the IoT application 172. Upon accessing the device 102a using the device's cached access credentials, for example, the IoT application 172 can establish a secure communication session with the device, can retrieve data from the device (e.g., current device status information and other sorts of data). As another example, the IoT application 172 can transmit control commands to the device 102a over the secure connection. By receiving user-facing access credentials through the application's user interface, and handling the access credentials of the device 102a in the background, for example, system security can be maintained without receiving or exposing the locally cached access credentials of the device 102a through the user interface.

Although the present example shows a successful use of cached access credentials for accessing an IoT device over a network, in some scenarios, the cached access credentials may not permit access to the IoT device (e.g., for scenarios in which the cached access credentials are invalid due to data synchronization errors, for scenarios in which access credentials have been updated through a manual process, or other non-standard scenarios). For such scenarios, the IoT application 172 can transmit a request for current access credentials for the device 102a to the credential service 120 through the gateway 122. As another example, the IoT application 172 can raise an alert that indicates a possible system error or security breach in the system 100.

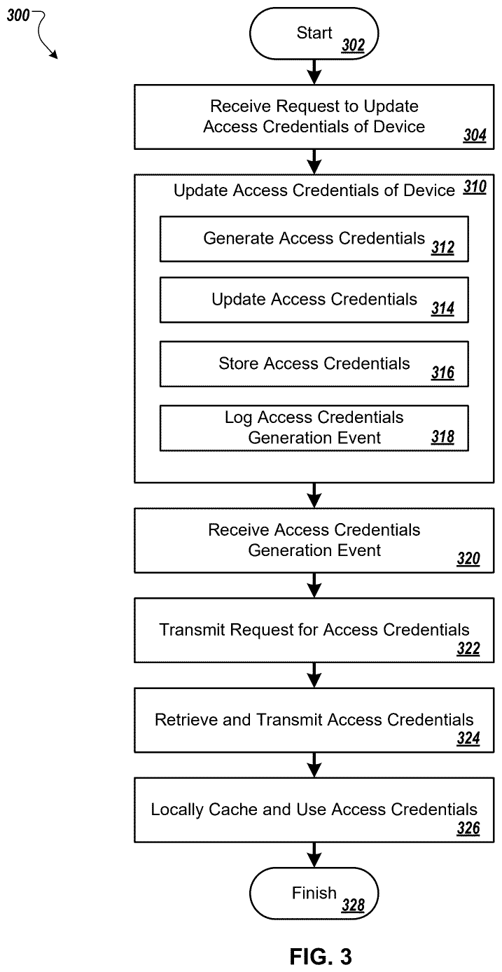

FIG. 3 is a flow diagram of an example technique 300 for performing automated handling of access credentials for Internet of Things (IoT) devices. Operations of the technique 300, for example, can be performed for an IoT device, in response to a scheduled request (e.g., when a scheduler determines that the device is to undergo an access credential update according to a rotating schedule), in response to an ad hoc request (e.g., when the device is newly added to a network, when the device has become compromised and is to have its access credentials updated, etc.), and/or in response to another sort of scenario in which updating the device's access credentials is appropriate. In the present example, the technique 300 can be performed by components of the system 100 (e.g., shown in FIG. 1) according to the automated handling stages (C) to (O) (e.g., shown in FIGS. 2B-2E), and will be described as such for clarity. However, the technique 300 can also be performed by other platforms and systems.

At 302, the example technique 300 starts, and at 304, a request to update access credentials of an IoT device is received. In the present example, the device service platform 130 provides the request 210 to update the access credentials of the device 102a, which is in turn received through the gateway 122 of the access credentials service 120. Operations for transmitting and receiving a request to update access credentials of an IoT device are also described with respect to stage (C), shown in FIG. 2B.

At 310, in response to receiving the request to update access credentials of the IoT device, access credentials of the IoT device are automatically updated. In general, automatically updating the access credentials of the IoT device can include the performance of various operations by an access credential service, including the generation of access credentials for the IoT device, the application of an access credentials update (that includes the generated access credentials) to the IoT device, the storing of the generated access credentials, and the logging of an access credential generation event.

At 312, access credentials of the IoT device are automatically generated. In the present example, the access credential service 120 uses the access credential generator 126 to randomly generate access credentials for the device 102a. Operations for randomly generating access credentials are also described with respect to stage (D), shown in FIG. 2B.

At 314, access credentials of the IoT device are updated. In the present example, the access credential service 120 applies the access credentials update 216 (e.g., including the randomly generated access credentials) to the device 102a. Operations for updating access credentials are also described with respect to stage (E), shown in FIG. 2B.

At 316, access credentials of the IoT device are stored. In the present example, the access credential service 120 stores the access credentials 214 for the device 102a, along with a unique identifier for the device 102a on the networks 150, 152, at the access credentials data store 162. Operations for storing access credentials are also described with respect to stage (F), shown in FIG. 2B.

At 318, an access credential generation event for the IoT device is logged. In the present example, the access credential service 120 logs the access credential generation event 230 (including the unique identifier for the device 102a) to the event data store 160. Operations for logging access credential generation events are also described with respect to stage (G), shown in FIG. 2C.

At 320, the access credential generation event is received. In general, various IoT applications being executed by various IoT management devices can receive access credential generation events (e.g., through a topic subscription to an event streaming platform, or another suitable data transmission technique). In the present example, the inventory service 134 of the device service platform 130 and the IoT application 172 of the client computing device 170 can each receive access credential generation event data that pertains to the generation, updating, and storing of access credentials for the device 102a. Operations for receiving access credential generation event data are also described with respect to stages (H₁) and (H₂), shown in FIG. 2C.

At 322, in response to receiving the access credential generation event, a request for access credentials of the IoT device is transmitted. In general, a request for access credentials of an IoT device can be transmitted by a computing device that executes an IoT application, to an access credential service. In the present example, the device service platform 130 that executes the inventory service 134, and the client computing device that executes the IoT application 172 can each transmit a respective request for access credentials of the device 102a. Operations for requesting access credentials of IoT devices are also described with respect to stages (I₁) and (I₂), shown in FIG. 2C.

At 324, in response to receiving the request for access credentials of the IoT device, the access credentials are retrieved and transmitted. In general, access credentials of an IoT device can be retrieved by an access credential service from an access credential data store, and the access credentials can be transmitted by the access credential service to the IoT application. In the present example, the access credential service 120 can retrieve access credentials data that pertains to the device 102a from the access credential data store 162, and can transmit respective access credentials data packets (e.g., 234a and 234b) to the inventory service 134 and to the IoT application 172. Operations for retrieving and transmitting access credentials area also described with respect to stages (I₁) and (I₂), shown in FIG. 2C.

At 326, access credentials of the IoT device are locally cached and are used. In general, an IoT application can locally cache access credentials for an IoT device at an IoT management device (e.g., in memory), and the locally cached access credentials can be used by the IoT application to access the IoT device over a network when the logic of the IoT application triggers a request to receive data from and/or to send a control command to the IoT device. In the present example, the inventory service 134 of the device service platform 130 can access the cached access credentials 246 of the device 102a (e.g., “Device A”), and the inventory service 134 can use the cached access credentials 246 to access the device 102a (e.g., during stages (J) to (L), shown in FIG. 2D). Similarly, in the present example, the IoT application 172 executed by the client computing device 170 can access the cached access credentials 256 of the device 102a (e.g., “Device A”), and the IoT application 172 can use the cached access credentials 256 to access the device 102a (e.g., during stages (M) to (O), shown in FIG. 2E). Through the use of cached access credentials data for various IoT devices, for example, reliance on the access credential service 120 can be reduced, while maintaining security of the IoT devices, and while improving the responsive ness of IoT applications. After using the access credentials of the IoT device, the example technique finishes at 328.

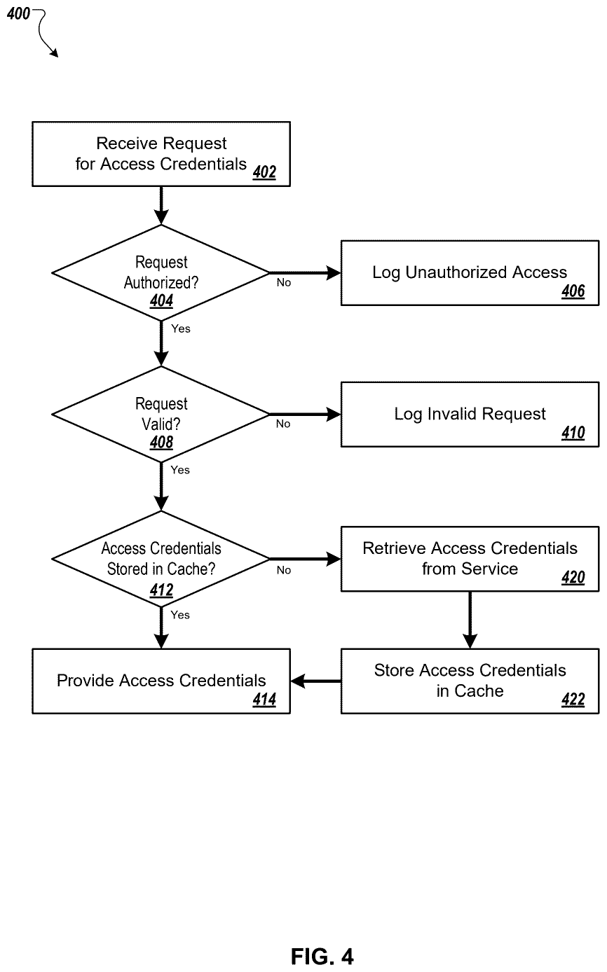

FIG. 4 is a flow diagram of an example technique 400 for automatically handling a request for access credentials. Operations of the technique 400, for example, can be performed for an Internet of Things (IoT) device, upon receipt of a request for access credentials by an IoT application (e.g., the inventory service 134 of the device service platform 130, the IoT application 172 executed by the client device 170, or another sort of IoT application). In the present example, the technique 400 can be performed by components of the system 100 (e.g., shown in FIG. 1) according to the stages (J) to (L) (e.g., shown in FIG. 2D) or according to the stages (M) to (O) (e.g., shown in FIG. 2E), and will be described as such for clarity. However, the technique 400 can also be performed by other platforms and systems.

At 402, a request for access credentials is received by an IoT application. For example, the IoT application (e.g., the inventory service 134, the IoT application 172, or another sort of IoT application) can receive the request for access credentials for an IoT device (e.g., the device 102a).

At 404, a determination is performed of whether the request for access credentials is authorized. For example, the IoT application can determine whether the request for access credentials is authorized by checking user-facing access credentials (e.g., the user-facing access credentials 250, received during stage (M) shown in FIG. 2E) received in association with the request for access credentials. As another example, the IoT application can determine whether the request is authorized by checking whether a trigger request (e.g., the trigger request 240, received during stage (J) shown in FIG. 2D) received for an IoT device is from an authorized application process. At 406, if the request for access credentials is not authorized, an unauthorized access event is logged. For example, the IoT application can log the unauthorized access event at the event data store 160.

At 408, a determination is performed of whether the request for access credentials is valid. For example, the IoT application can determine whether the request for access credentials is formatted correctly, whether the request for access credentials is for a device that exists on the networks 150, 152, and so forth. At 410, if the request for access credentials is invalid, an invalid request event is logged. For example, the IoT application can log the invalid request event at the event data store 160.

At 412, a determination is performed of whether the access credentials are stored in a cache. For example, the IoT application can access the local cache 256 (e.g., during stage (N), shown in FIG. 2E) to determine whether the access credentials for the IoT device (e.g., device 102a) are present in the cache. As another example, the inventory service 134 can access the local cache 246 (e.g., during stage (K), shown in FIG. 2D). At 414, if the access credentials are stored in the cache, the access credentials are provided to the IoT application.

At 420, if the access credentials are not stored in the cache, the access credentials are retrieved from an access credentials service. For example, if the IoT application determines that the access credentials for the IoT device (e.g., device 102a) are not present in the local cache 256 (e.g., during stage (N) or during stage (K)), the IoT application can request the access credentials from the access credential service 120. At 422, the access credentials are stored in the cache (e.g., by the IoT application, after receiving the access credentials from the access credential service 120), and at 414 the access credentials are provided to the IoT application.

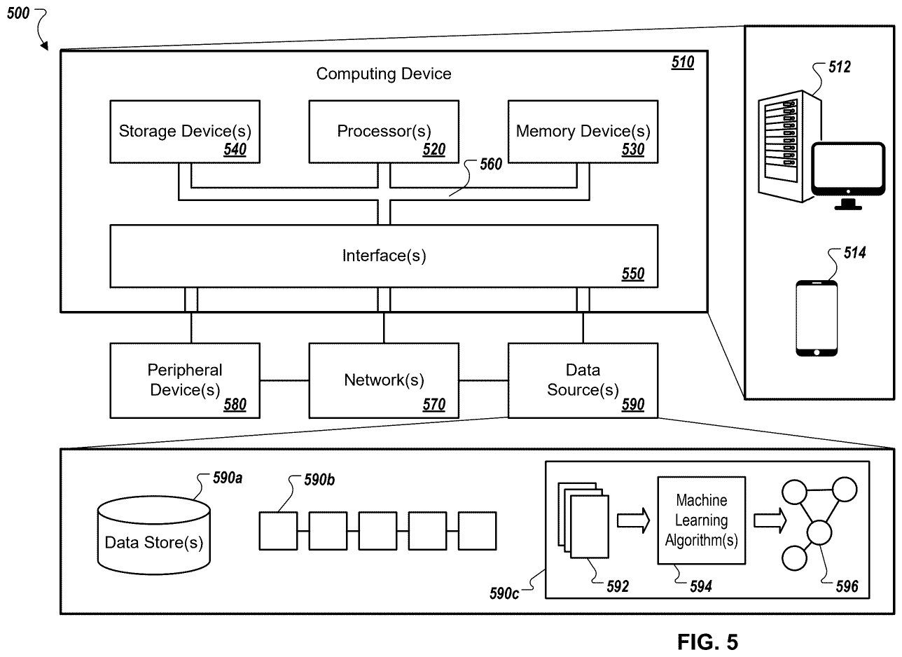

FIG. 5 is a schematic diagram that shows an example of a computing system 500 that can be used to implement the techniques described herein. The computing system 500 includes one or more computing devices (e.g., computing device 510), which can be in wired and/or wireless communication with various peripheral device(s) 580, data source(s) 590, and/or other computing devices (e.g., over network(s) 570). The computing device 510 can represent various forms of stationary computers 512 (e.g., workstations, kiosks, servers, mainframes, edge computing devices, quantum computers, etc.) and mobile computers 514 (e.g., laptops, tablets, mobile phones, personal digital assistants, wearable devices, etc.). In some implementations, the computing device 510 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 510, and an entire system can be made up of multiple devices communicating with each other. For example, the computing device 510 can be part of a computing system that includes a network of computing devices, such as a cloud-based computing system, a computing system in an internal network, or a computing system in another sort of shared network. Processors of the computing device (510) and other computing devices of a computing system can be optimized for different types of operations, secure computing tasks, etc. The components shown herein, and their functions, are meant to be examples, and are not meant to limit implementations of the technology described and/or claimed in this document.

The computing device 510 includes processor(s) 520, memory device(s) 530, storage device(s) 540, and interface(s) 550. Each of the processor(s) 520, the memory device(s) 530, the storage device(s) 540, and the interface(s) 550 are interconnected using a system bus 560. The processor(s) 520 are capable of processing instructions for execution within the computing device 510, and can include one or more single-threaded and/or multi-threaded processors. The processor(s) 520 are capable of processing instructions stored in the memory device(s) 530 and/or on the storage device(s) 540. The memory device(s) 530 can store data within the computing device 510, and can include one or more computer-readable media, volatile memory units, and/or non-volatile memory units. The storage device(s) 540 can provide mass storage for the computing device 510, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 550 can include various communications interfaces (e.g., USB, Near-Field Communication (NFC), Bluetooth, WiFi, Ethernet, wireless Ethernet, etc.) that can be coupled to the network(s) 570, peripheral device(s) 580, and/or data source(s) 590 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 550 can include a control interface that receives commands from an input device (e.g., operated by a user) and converts the commands for submission to the processors 520. The interface(s) 550 can include a display interface that includes circuitry for driving a display to present visual information to a user. The interface(s) 550 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 570 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 510 can communicate with the peripheral device(s) 580, the data source(s) 590, and/or other computing devices over the network(s) 570. In some implementations, the computing device 510 can directly communicate with the peripheral device(s) 580, the data source(s), and/or other computing devices.

The peripheral device(s) 580 can provide input/output operations for the computing device 510. Input devices (e.g., keyboards, pointing devices, touchscreens, microphones, cameras, scanners, sensors, etc.) can provide input to the computing device 510 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 510 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 590 can provide data for use by the computing device 510, and/or can maintain data that has been generated by the computing device 510 and/or other devices (e.g., data collected from sensor devices, data aggregated from various different data repositories, etc.). In some implementations, one or more data sources can be hosted by the computing device 510 (e.g., using the storage device(s) 540). In some implementations, one or more data sources can be hosted by a different computing device. Data can be provided by the data source(s) 590 in response to a request for data from the computing device 510 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 590a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 590b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 590c. The machine learning system(s) 590c, for example, can be used to analyze data from various sources (e.g., data provided by the computing device 510, data from the data store(s) 590a, data from the blockchain(s) 590b, and/or data from other data sources), to identify patterns in the data, and to draw inferences from the data patterns. In general, training data 592 can be provided to one or more machine learning algorithms 594, and the machine learning algorithm(s) can generate a machine learning model 596. Execution of the machine learning algorithm(s) can be performed by the computing device 510, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents requests for access credentials by an access credentials service. The machine learning model that results from the machine learning algorithm(s) can be used to determine request patterns for access credentials by various applications and for various devices (e.g., how often access credentials are requested for particular devices and by which applications). Use of the machine learning model can provide the benefit of identifying system bottlenecks, and improving caching schemes for applications that request access credentials of devices (e.g., by determining which applications may benefit from implementing access credential caching, and which applications may benefit from not implementing access credential caching).

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer-implemented method for automatically handling access credentials for internet of things (IoT) devices on a network, comprising:
receiving, by an access credential service, a request to update access credentials of an IoT device;
in response to receiving the request to update access credentials of the IoT device, updating, by the access credential service, access credentials of the IoT device, the updating comprising:
automatically generating access credentials for the IoT device;
updating the access credentials of the IoT device;
storing, at an access credential data store, the access credentials for the IoT device along with a unique identifier for the IoT device on the network; and
logging an access credential generation event to an event data store, wherein the access credential generation event includes the unique identifier for the IoT device;
receiving, by an IoT application being executed by an IoT management device, the access credential generation event;
in response to receiving the access credential generation event, transmitting, by the IoT application and to the access credential service, a request for the access credentials for the IoT device;
in response to receiving the request for the access credentials for the IoT device, (i) retrieving, by the access credential service and from the access credential data store, access credentials for the IoT device, and (ii) transmitting, by the access credential service and to the IoT application, the access credentials for the IoT device;
locally caching, by the IoT application and at the IoT management device, the access credentials for the IoT device; and
using, by the IoT application, the locally cached access credentials for the IoT device to access the IoT device over the network.

2. The computer-implemented method of claim 1, wherein the IoT device is a security camera.

3. The computer-implemented method of claim 1, wherein the unique identifier of the IoT device is a media access control (MAC) address.

4. The computer-implemented method of claim 1, wherein the event data store is an event streaming platform, and wherein the IoT application subscribes to the event data store.

5. The computer-implemented method of claim 1, wherein the request to update access credentials of the IoT device and the request for the access credentials for the IoT device are each received through an application programming interface of the access credential service.

6. The computer-implemented method of claim 1, wherein automatically generating access credentials for the IoT device comprises:
executing a standard access credential generator that is configured to randomly generate access credentials that satisfy access credential specifications across a plurality of different device models of IoT devices.

7. The computer-implemented method of claim 1, wherein automatically generating access credentials for the IoT device comprises:
executing a model-specific access credential generator that is configured to randomly generate access credentials that satisfy a particular access credential specification for a particular device model of the IoT device.

8. The computer-implemented method of claim 1, wherein updating the access credentials for the IoT device comprises:
establishing a remote connection to the IoT device; and
executing a configuration settings application script that updates the access credentials of the IoT device, using a protocol of a particular device model of the IoT device.

9. The computer-implemented method of claim 1, further comprising:
defining a plurality of IoT device groups;
assigning a substantially similar number of the IoT devices to each IoT device group of the plurality of IoT device groups;
defining an access credential update schedule, wherein the IoT devices of a given IoT device group are scheduled to undergo access credential updates during a same time period, and wherein the IoT devices of different IoT device groups are scheduled to undergo access credential updates during different time periods; and
in response to determining that a time period of one of the IoT device groups has begun according to its access credential update schedule, automatically transmitting requests to the access credential service during the time period, to update access credentials of IoT devices of the one of the IoT device groups.

10. The computer-implemented method of claim 1, further comprising:
receiving, by the IoT application being executed by the IoT management device, user-facing access credentials entered through a user interface of the IoT application;
validating, by the IoT application, the user-facing access credentials; and
in response to a successful validation of the user-facing access credential, using the locally cached access credentials for the IoT device to access the IoT device over the network, without receiving or exposing the locally cached access credentials through the user interface.

11. A computer system for automatically handling access credentials for internet of things (IoT) devices on a network, comprising:
one or more data processing apparatuses including one or more processors, memory, and storage devices storing instructions that, when executed, cause the one or more processors to perform operations comprising:
receiving, by an access credential service, a request to update access credentials of an IoT device;
in response to receiving the request to update access credentials of the IoT device, updating, by the access credential service, access credentials of the IoT device, the updating comprising:
automatically generating access credentials for the IoT device;
updating the access credentials of the IoT device;
storing, at an access credential data store, the access credentials for the IoT device along with a unique identifier for the IoT device on the network; and
logging an access credential generation event to an event data store, wherein the access credential generation event includes the unique identifier for the IoT device;
receiving, by an IoT application being executed by an IoT management device, the access credential generation event;
in response to receiving the access credential generation event, transmitting, by the IoT application and to the access credential service, a request for the access credentials for the IoT device;
in response to receiving the request for the access credentials for the IoT device, (i) retrieving, by the access credential service and from the access credential data store, access credentials for the IoT device, and (ii) transmitting, by the access credential service and to the IoT application, the access credentials for the IoT device;
locally caching, by the IoT application and at the IoT management device, the access credentials for the IoT device; and
using, by the IoT application, the locally cached access credentials for the IoT device to access the IoT device over the network.

12. The computer system of claim 11, wherein the IoT device is a security camera.

13. The computer system of claim 11, wherein the unique identifier of the IoT device is a media access control (MAC) address.

14. The computer system of claim 11, wherein the event data store is an event streaming platform, and wherein the IoT application subscribes to the event data store.

15. The computer system of claim 11, wherein the request to update access credentials of the IoT device and the request for the access credentials for the IoT device are each received through an application programming interface of the access credential service.

16. The computer system of claim 11, wherein automatically generating access credentials for the IoT device comprises:
executing a standard access credential generator that is configured to randomly generate access credentials that satisfy access credential specifications across a plurality of different device models of IoT devices.

17. The computer system of claim 11, wherein automatically generating access credentials for the IoT device comprises:
executing a model-specific access credential generator that is configured to randomly generate access credentials that satisfy a particular access credential specification for a particular device model of the IoT device.

18. The computer system of claim 11, wherein updating the access credentials for the IoT device comprises:
establishing a remote connection to the IoT device; and
executing a configuration settings application script that updates the access credentials of the IoT device, using a protocol of a particular device model of the IoT device.

19. The computer system of claim 11, further comprising:
defining a plurality of IoT device groups;
assigning a substantially similar number of the IoT devices to each IoT device group of the plurality of IoT device groups;
defining an access credential update schedule, wherein the IoT devices of a given IoT device group are scheduled to undergo access credential updates during a same time period, and wherein the IoT devices of different IoT device groups are scheduled to undergo access credential updates during different time periods; and
in response to determining that a time period of one of the IoT device groups has begun according to its access credential update schedule, automatically transmitting requests to the access credential service during the time period, to update access credentials of IoT devices of the one of the IoT device groups.

20. The computer system of claim 11, further comprising:
receiving, by the IoT application being executed by the IoT management device, user-facing access credentials entered through a user interface of the IoT application;
validating, by the IoT application, the user-facing access credentials; and
in response to a successful validation of the user-facing access credential, using the locally cached access credentials for the IoT device to access the IoT device over the network, without receiving or exposing the locally cached access credentials through the user interface.
